(19) United States
(12) Patent Application Publication
(10) Pub. No.: US 2025/0201239 A1
(43) Pub. Date: Jun. 19, 2025

(54) SPEECH RECOGNITION METHOD, SPEECH RECOGNITION MODEL, ELECTRONIC DEVICE AND STORAGE MEDIUM

(71) Applicant: Zhejiang Alibaba Robot Co., Ltd., Hangzhou (CN)

(72) Inventors: Zhifu GAO, Hangzhou (CN); Shiliang ZHANG, Hangzhou (CN)

(21) Appl. No.: 18/685,222

(22) PCT Filed: Nov. 8, 2022
(86) PCT No.: PCT/CN2022/130734

§ 371 Date: Feb. 20, 2024

(30) Foreign Application Priority Data
Dec. 16, 2021 (CN) 202111538265.3

(51) Int. Cl. G10L 15/14; G10L 15/18

(52) U.S. Cl. CPC G10L 15/14; G10L 15/1815

(57) ABSTRACT

Embodiments of the present application provide a speech recognition method, a speech recognition model, an electronic device and a storage medium. The speech recognition method includes: obtaining an acoustic representation of to-be-recognized speech; determining a character probability corresponding to each frame vector in the acoustic representation, where the character probability is used to indicate a probability of recognizing corresponding character speech based on a current frame vector; predicting, according to the character probability corresponding to each frame vector, the number of characters included in the to-be-recognized speech and a frame boundary of each character to obtain a prediction result; extracting a vector representation of each piece of character speech from the acoustic representation according to the prediction result; obtaining a recognition result of the to-be-recognized speech according to the vector representation of each piece of character speech. This solution can improve the speed of speech recognition.

### CROSS-REFERENCE TO RELATED APPLICATIONS

The present application is a National Stage of International Application No. PCT/CN2022/130734, filed on Nov. 8, 2022, which claims priority to Chinese patent application No. 202111538265.3, filed to China National Intellectual Property Administration on Dec. 16, 2021 and entitled “SPEECH RECOGNITION METHOD, SPEECH RECOGNITION MODEL, ELECTRONIC DEVICE AND STORAGE MEDIUM”. These applications are hereby incorporated by reference in their entireties.

### TECHNICAL FIELD

Embodiments of the present application relate to the field of artificial intelligence technologies and, in particular, to a speech recognition method, a speech recognition model, an electronic device and a storage medium.

### BACKGROUND

Speech recognition technology is a technology that enables a machine to convert speech signals into corresponding text or commands through a process of recognition and understanding. An end-to-end speech recognition system has attracted more and more attention from academia and industry. Compared to a traditional hybrid modeling solution, the end-to-end speech recognition system optimizes an acoustic model and a language model jointly through one model, which can not only reduce the complexity of model training but also improve the speech recognition performance of the model.

At present, the end-to-end speech recognition system adopts an auto-regressive model (Auto-regressive Transformer) to realize joint optimization of the acoustic model and the language model, so as to achieve a better performance improvement on general tasks.

However, in the end-to-end speech recognition system using the auto-regressive model, an auto-regressive decoder needs to sequentially recognize characters that have not been recognized based on recognized characters when converting a speech feature into text. Since recognizing each character requires calling a speech recognition model once, when input speech data is long, the end-to-end speech recognition system needs to take a long time to output a recognition result, resulting in slower speed of speech recognition.

### SUMMARY

In view of the above, embodiments of the present application provide a speech recognition method, a speech recognition model, an electronic device and a storage medium to at least solve or alleviate the above problems.

According to a first aspect of the embodiments of the present application, a speech recognition method is provided, including: obtaining an acoustic representation of to-be-recognized speech; determining a character probability corresponding to each frame vector in the acoustic representation, where the character probability is used to indicate a probability of recognizing corresponding character speech based on a current frame vector; predicting, according to the character probability corresponding to each frame vector, the number of characters included in the to-be-recognized speech and a frame boundary of each character to obtain a prediction result; extracting a vector representation of each piece of character speech from the acoustic representation according to the prediction result; obtaining a recognition result of the to-be-recognized speech according to the vector representation of each piece of character speech.

According to a second aspect of the embodiments of the present application, a method for providing a speech recognition service is provided, including: obtaining conference speech data collected in real time; obtaining an acoustic representation of the conference speech data; determining a character probability corresponding to each frame vector in the acoustic representation, where the character probability is used to indicate a probability of recognizing corresponding character speech based on a current frame vector; predicting, according to the character probability corresponding to each frame vector, the number of characters included in the conference speech data and a frame boundary of each character to obtain a prediction result; extracting a vector representation of each piece of character speech from the acoustic representation according to the prediction result; obtaining a recognition result of the conference speech data according to the vector representation of each piece of character speech; recording the recognition result of the conference speech data into an associated conference record file.

According to a third aspect of the embodiments of the present application, a speech interaction method is provided, including: obtaining speech data input by a user; obtaining an acoustic representation of the speech data; determining a character probability corresponding to each frame vector in the acoustic representation, where the character probability is used to indicate a probability of recognizing corresponding character speech based on a current frame vector; predicting, according to the character probability corresponding to each frame vector, the number of characters included in the speech data and a frame boundary of each character to obtain a prediction result; extracting a vector representation of each piece of character speech from the acoustic representation according to the prediction result; obtaining a recognition result of the speech data according to the vector representation of each piece of character speech; determining feedback text according to the recognition result of the speech data, and converting the feedback text into speech for play, so as to respond to a user input.

According to a fourth aspect of the embodiments of the present application, a method for implementing court self-service case filing is provided, including: receiving, by a self-service case filing all-in-one machine device, case filing request information input by speech; obtaining an acoustic representation of received speech data; determining a character probability corresponding to each frame vector in the acoustic representation, where the character probability is used to indicate a probability of recognizing corresponding character speech based on a current frame vector; predicting, according to the character probability corresponding to each frame vector, the number of characters included in the speech data and a frame boundary of each character to obtain a prediction result; extracting a vector representation of each piece of character speech from the acoustic representation according to the prediction result; obtaining a recognition result of the speech data according to the vector representation of each piece of character speech; recording the recognition result of the speech data into an associated case filing information database.

According to a fifth aspect of the embodiments of the present application, a speech recognition model is provided, including: an encoder, configured to obtain an acoustic representation of to-be-recognized speech; a predictor, configured to determine a character probability corresponding to each frame vector in the acoustic representation, predict, according to the character probability corresponding to each frame vector, the number of characters included in the to-be-recognized speech and a frame boundary of each character to obtain a prediction result, and extract a vector representation of each piece of character speech from the acoustic representation according to the prediction result, where the character probability is used to indicate a probability of recognizing corresponding character speech based on a current frame vector; a decoder, configured to obtain a recognition result of the to-be-recognized speech according to the vector representation of each piece of character speech.

According to a sixth aspect of the embodiments of the present application, an electronic device is provided, including a processor, a memory, a communication interface and a communication bus, where the processor, the memory and the communication interface communicate with each other through the communication bus; the memory is configured to store at least one executable instruction, and the executable instruction causes the processor to execute operations corresponding to the speech recognition method according to the first aspect.

According to a seventh aspect of the embodiments of the present application, a computer storage medium having a computer program stored thereon is provided, and when the program is executed by a processor, the speech recognition method according to the first aspect is implemented.

In the above technical solution, after obtaining the acoustic representation of the to-be-recognized speech, the character probability of each frame vector in the acoustic representation is determined, and then the number of characters included in the to-be-recognized speech and the frame boundary of each character can be predicted according to the character probability. Based on the number of characters and the frame boundary, the vector representation of each piece of character speech can be extracted from the acoustic representation, and then the recognition result of the to-be-recognized speech can be obtained based on vector representations of respective pieces of character speech. After obtaining the vector representation of each piece of character speech, the vector representations of the respective pieces of character speech can be input into a non-auto-regressive decoder. The vector representations of the pieces of character speech are decoded simultaneously through the non-auto-regressive decoder to obtain a character corresponding to each piece of character speech, that is, to obtain the recognition result of the to-be-recognized speech. Since there is no need to sequentially recognize the respective pieces of character speech in the to-be-recognized speech, the speech recognition model only needs to be called once, which reduces the number of calls to the speech recognition model and can thus improve the speed of speech recognition.

### BRIEF DESCRIPTION OF THE DRAWINGS

In order to explain technical solutions in embodiments of the present application or in the prior art more clearly, drawings required to be used in the description of the embodiments or the prior art will be introduced briefly in the following. It is obvious that the drawings described in the following description are intended for some embodiments described in the embodiments of the present application. For those with ordinary skill in the art, other drawings may also be obtained based on these drawings.

FIG. 1 is a schematic diagram of an exemplary system to which an embodiment of the present application is applied.

FIG. 2 is a flowchart of a speech recognition method according to an embodiment of the present application.

FIG. 3 is a schematic diagram of an acoustic representation according to an embodiment of the present application.

FIG. 4 is a schematic diagram of a speech recognition model according to an embodiment of the present application.

FIG. 5 is a flowchart of a decoder training method according to another embodiment of the present application.

FIG. 6 is a schematic diagram of a decoder training process according to an embodiment of the present application.

FIG. 7 is a flowchart of a method for providing a speech recognition service according to an embodiment of the present application.

FIG. 8 is a flowchart of a speech interaction method according to an embodiment of the present application.

FIG. 9 is a flowchart of a method for implementing court self-service case filing according to an embodiment of the present application.

FIG. 10 is a schematic diagram of a speech recognition apparatus according to an embodiment of the present application.

FIG. 11 is a schematic diagram of an electronic device according to an embodiment of the present application.

### DESCRIPTION OF EMBODIMENTS

In order to make persons in the art better understand technical solutions in embodiments of the present application, the technical solutions in the embodiments of the present application will be described clearly and comprehensively in conjunction with the accompanying drawings in the embodiments of the present application. Obviously, the described embodiments are part of the embodiments of the present application, but not all of the embodiments. Based on the embodiments of the present application, all other embodiments obtained by those of ordinary skill in the art belong to the protection scope of the embodiments of the present application.

In the embodiments of the present application, in order to improve the speed of speech recognition, after an acoustic representation of to-be-recognized speech is obtained through an encoder, character speech corresponding to different frame vectors in the acoustic representation is predicted, and then a vector representation of each piece of character speech in the to-be-recognized speech is determined according to a prediction result. Then, the vector representation of each piece of character speech and the acoustic representation of the to-be-recognized speech are input into a decoder, and the decoder simultaneously recognizes respective pieces of character speech in the to-be-recognized speech based on the vector representation of each piece of character speech and the acoustic representation of the to-be-recognized speech to obtain a recognition result of the to-be-recognized speech. The decoder of an end-to-end speech recognition model is realized through a non-auto-regressive decoder. After inputting the vector representation of each piece of character speech in the to-be-recognized speech and the acoustic representation of the to-be-recognized speech into the decoder, the decoder simultaneously recognizes the respective pieces of character speech in the to-be-recognized speech. The speech recognition model only needs to be called once in a speech recognition process, which can improve the speed of speech recognition, and better apply to application scenarios with high real-time requirements for speech recognition.

When being specifically implemented, speech recognition methods provided by embodiments of the present application can be used in various application functional scenarios. For example, a cloud service system may provide a cloud speech recognition service, and if the service needs to realize end-to-end speech recognition, it can be implemented through solutions provided by the embodiments of the present application. Specifically, the cloud service system provides a speech recognition model, and provides a cloud speech recognition interface for users, where multiple users may call the interface in their respective application systems. After receiving the call, the cloud service system runs a relevant processing program to implement speech recognition through the speech recognition model, and returns a result of speech recognition. In addition, the speech recognition methods provided by the embodiments of the present application can also be used in a localized device, such as a conference record generating system, a navigation robot in a shopping mall, a self-service case filing all-in-one machine of a court, etc.

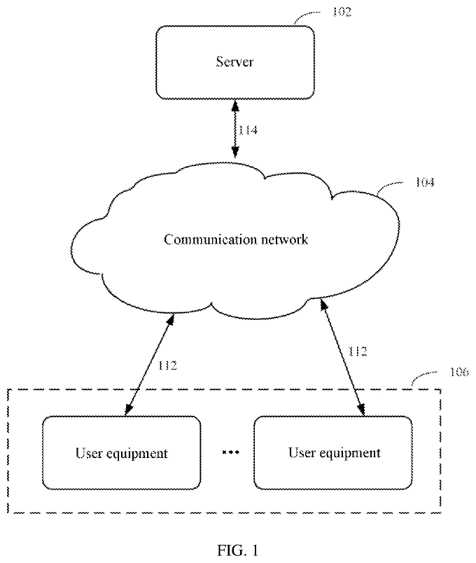

FIG. 1 illustrates an exemplary system to which a speech recognition method of an embodiment of the present application applies. As shown in FIG. 1, a system 100 may include a server 102, a communication network 104 and/or one or more user equipments 106, where multiple user equipments are taken as an example in FIG. 1.

The server 102 may be any suitable server for storing information, data, programs and/or any other suitable type of content. In some embodiments, the server 102 may execute any suitable function. For example, in some embodiments, the server 102 may be used for speech recognition. As an example, in some embodiments, the server 102 may be used for performing speech recognition through a non-auto-regressive speech recognition model. As another example, in some embodiments, the server 102 may be used to send a speech recognition result to a user equipment.

In some embodiments, the communication network 104 may be any suitable combination of one or more wired and/or wireless networks. For example, the communication network 104 may include any one or more of the following: an Internet, an intranet, a wide area network (WAN), a local area network (LAN), a wireless network, a digital subscriber line (DSL) network, a frame relay network, an asynchronous transfer mode (ATM) network, a virtual private network (VPN) and/or any other suitable communication network. The user equipment 106 can connect to the communication network 104 through one or more communication links (e.g., a communication link 112), and the communication network 104 can connect to the server 102 through one or more communication links (e.g., a communication link 114). The communication link may be any communication link suitable for transmitting data between the user equipment 106 and the server 102, such as a network link, a dial-up link, a wireless link, a hardwired link, any other suitable communication link, or any suitable combination of such links.

The user equipment 106 may include any one or more user equipments suitable for receiving speech data and collecting speech data. In some embodiments, the user equipment 106 may include any suitable type of device. For example, in some embodiments, the user equipment 106 may include a mobile device, a tablet computer, a laptop computer, a desktop computer, a wearable computer, a game console, a media player, a vehicle entertainment system, and/or any other suitable type of user equipment.

Although the server 102 is illustrated as one device, in some embodiments, any suitable number of devices may be used to execute functions executed by the server 102. For example, in some embodiments, multiple devices may be used to implement the functions executed by the server 102. Or, a cloud service may be used to implement the functions of the server 102.

Based on the above system, the embodiments of the present application provide a speech recognition method, which is explained through multiple embodiments.

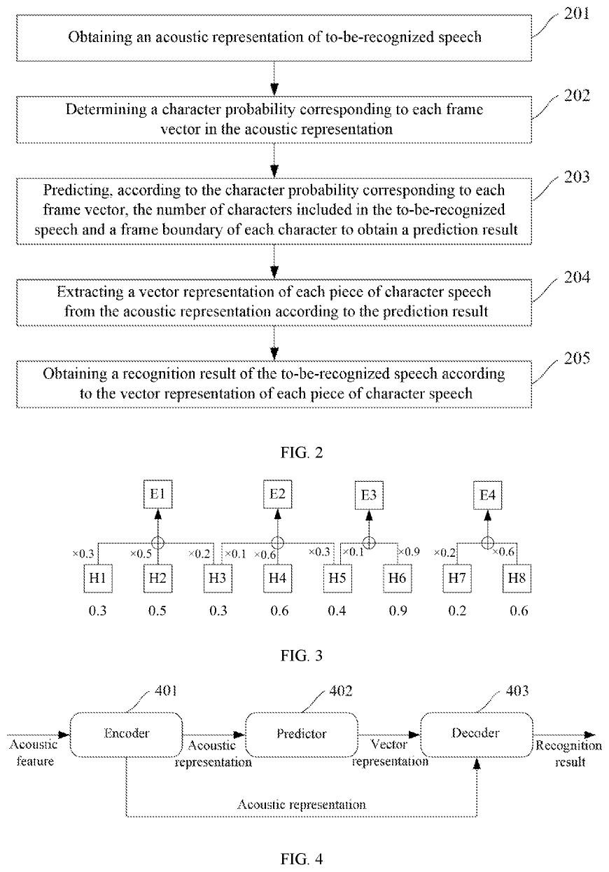

FIG. 2 is a schematic flowchart of a speech recognition method provided by an embodiment of the present application. As shown in FIG. 2, the method includes the following steps.

Step 201: obtaining an acoustic representation of to-be-recognized speech.

The acoustic representation is used to characterize an audio feature of the to-be-recognized speech through a vector, and different speech data correspond to different acoustic representations. The acoustic representation can be obtained through an encoder. Specifically, an acoustic feature, such as a Fbank (Filter Bank) feature or an MFCC (Mel-scale Frequency Cepstrum Coefficient) feature of the to-be-recognized speech is first extracted, and the extracted acoustic feature is then input into a pre-trained encoder. The acoustic feature is encoded through the encoder to obtain the acoustic representation of the to-be-recognized speech.

Step 202: determining a character probability corresponding to each frame vector in the acoustic representation.

The acoustic representation includes multiple frame vectors, and depending on a specific way in which the encoder generates the acoustic representation, each frame vector in the acoustic representation corresponds to audio data of a different duration in the to-be-recognized speech. The audio data corresponding to the frame vectors in the acoustic representation constitutes the complete to-be-recognized speech. The to-be-recognized speech includes one or more pieces of character speech, and audio data corresponding to one frame vector in the acoustic representation may be part/all of one piece of character speech, or audio data corresponding to one frame vector may be part/all of one piece of character speech and part/all of another piece of character speech.

After obtaining the acoustic representation of the to-be-recognized speech, the character probability corresponding to each frame vector in the acoustic representation can be determined separately. The character probability corresponding to a frame vector is used to indicate a probability of recognizing corresponding character speech based on that frame vector. The character probability corresponding to the frame vector can be determined through a pre-trained predictor. The higher the character probability corresponding to the frame vector, the greater the probability of recognizing the corresponding character speech based on that frame vector.

FIG. 3 is a schematic diagram of an acoustic representation provided by an embodiment of the present application. As shown in FIG. 3, the acoustic representation of the to-be-recognized speech includes a total of eight frame vectors, namely, H1˜H8. After inputting the acoustic representation into the pre-trained predictor, the predictor determines that character probabilities corresponding to the eight frame vectors are 0.3, 0.5, 0.3, 0.6, 0.4, 0.9, 0.2 and 0.6, respectively. Taking the frame vector H2 as an example, the probability of recognizing corresponding character speech based on the frame vector H2 is 0.5.

Step 203: predicting, according to the character probability corresponding to each frame vector, the number of characters included in the to-be-recognized speech and a frame boundary of each character to obtain a prediction result.

For a frame vector in the to-be-recognized speech, if a distance between audio data corresponding to the frame vector and character speech corresponding to the frame vector is small, the probability of recognizing the character speech based on the frame vector is high, and the character probability corresponding to the frame vector is high; if the distance between the audio data corresponding to the frame vector and the character speech corresponding to the frame vector is large, the probability of recognizing the character speech based on the frame vector is small, that is, the character probability corresponding to the frame vector is small. Since the character speech is distributed sequentially in the to-be-recognized speech, the number of characters included in the to-be-recognized speech and the frame boundary of each character can be predicted according to character probabilities corresponding to the frame vectors. Which frame vectors correspond to a same piece of character speech can be determined through the frame boundary, and then according to the frame vectors corresponding to the same piece of character speech, that piece of character speech can be recognized.

Step 204: extracting a vector representation of each piece of character speech from the acoustic representation according to the prediction result.

Since the prediction result includes the number of characters included in the to-be-recognized speech and the frame boundary of each character, the frame vectors corresponding to the same piece of character speech in the acoustic representation can be determined according to the number of characters and the frame boundary, and then, the vector representation of each piece of character speech can be obtained separately according to the frame vectors corresponding to the same piece of character speech. That is, for each piece of character speech, the vector representation corresponding to that piece of character speech can be determined based on the frame vectors corresponding to that piece of character speech. The vector representation of a piece of character speech characterizes an audio feature of that piece of character speech, and a character corresponding to that piece of character speech is recognized based on the vector representation of that piece of character speech.

Step 205: obtaining a recognition result of the to-be-recognized speech according to the vector representation of each piece of character speech.

The to-be-recognized speech is formed by one or more pieces of character speech. After obtaining the vector representation corresponding to each piece of character speech, since characters corresponding to respective pieces of character speech can be recognized through the vector representation of each piece of character speech, the recognition result of the to-be-recognized speech can be obtained according to the vector representation of each piece of character speech.

It should be understood that after obtaining the vector representation of each piece of character speech, vector representations of the respective pieces of character speech may be input into a pre-trained non-auto-regressive decoder, and the vector representations of the respective pieces of character speech are decoded through the non-auto-regressive decoder to obtain the recognition result of the to-be-recognized speech.

In the embodiments of the present application, after obtaining the acoustic representation of the to-be-recognized speech, the character probability of each frame vector in the acoustic representation is determined, and then the number of characters included in the to-be-recognized speech and the frame boundary of each character can be predicted according to the character probability. Based on the number of characters and the frame boundary, the vector representation of each piece of character speech can be extracted from the acoustic representation, and then the recognition result of the to-be-recognized speech can be obtained based on the vector representations of the respective pieces of character speech. After obtaining the vector representation of each piece of character speech, the vector representations of the respective pieces of character speech can be input into the non-auto-regressive decoder. The vector representations of the respective pieces of character speech are decoded simultaneously through the non-auto-regressive decoder to obtain the character corresponding to each piece of character speech, that is, to obtain the recognition result of the to-be-recognized speech. Since there is no need to sequentially recognize the respective pieces of character speech in the to-be-recognized speech, a speech recognition model only needs to be called once, which reduces the number of calls to the speech recognition model and thus improves the speed of speech recognition.

In addition, by determining the character probability corresponding to each frame vector in the acoustic representation, the number of characters included in the to-be-recognized speech and the frame boundary of each character can be predicted according to the character probability corresponding to each frame vector. Compared to predicting the number of characters through a duration of the to-be-recognized speech, the number of characters included in the to-be-recognized speech and the frame boundary of each character can be predicted more accurately, and then the vector representations of the character speech obtained according to the number of characters and the frame boundary can reflect the audio feature of the character speech more accurately, thereby improving the accuracy of performing speech recognition according to the vector representations of the character speech.

In a possible implementation, when predicting the number of characters and the frame boundary according to the character probability in step 203, frame vectors in the acoustic representation are divided into at least one frame vector group according to the character probability corresponding to each frame vector, so that each piece of character speech in the to-be-recognized speech corresponds to one frame vector group, and the frame boundary corresponding to each character is a frame vector located at beginning and a frame vector located at end in a corresponding frame vector group.

When dividing the frame vectors into one or more frame vector groups, the frame vectors are sequentially divided according to an order of the frame vectors in the acoustic representation, that is, multiple adjacent frame vectors in the acoustic representation are divided into one frame vector group. Specifically, a probability threshold is preset, and when performing the dividing into the frame vector group, except for the last frame vector group, a sum of weight coefficients corresponding to frame vectors in each frame vector group is equal to the probability threshold. If a frame vector is located only in one frame vector group, a weight coefficient corresponding to that frame vector is equal to the character probability corresponding to that frame vector. If a frame vector is located in two frame vector groups, a sum of its corresponding weight coefficients in the two frame vector groups is equal to the character probability corresponding to that frame vector.

In a process of performing the dividing into the frame vector groups, if a sum of weight coefficients corresponding to remaining frame vectors is less than the probability threshold, the remaining frame vectors may be used as the last frame vector group or discarded according to a preset last place processing rule. For example, the preset last place processing rule is that: if the sum of weight coefficients is greater than 0.4, the remaining frame vectors are used as the last frame vector group; if the sum of weight coefficients corresponding to the remaining frame vectors is less than 0.4, the remaining frame vectors are discarded, and at this time, the sum of the weight coefficients corresponding to the frame vectors in each frame vector group is equal to the probability threshold. If the sum of the weight coefficients corresponding to the remaining frame vectors is greater than 0.4, the remaining frame vectors are divided into the last frame vector group, and at this time, the sum of the weight coefficients corresponding to the frame vectors in the last frame vector group is less than the probability threshold.

As shown in FIG. 3, according to the character probabilities corresponding to the eight frame vectors, the frame vectors H1˜H3 are divided into the first frame vector group, the frame vectors H3˜H5 are divided into the second frame vector group, the frame vectors H5˜H6 are divided into the third frame vector group, and the frame vectors H7˜H8 are divided into the fourth frame vector group. The frame vector H3 belongs to both the first frame vector group and second frame vector group, and the frame vector H5 belongs to both the second frame vector group and the third frame vector group. A weight coefficient of the frame vector H3 in the first frame vector group is 0.2, and a weight coefficient of the frame vector H3 in the second frame vector group is 0.1. A weight coefficient of the frame vector H5 in the second frame vector group is 0.3, and a weight coefficient of the frame vector H5 in the third frame vector group is 0.1. The sum of the weight coefficients corresponding to the frame vectors in each of the first frame vector group, the second frame vector group and the third frame vector group is equal to 1 (the preset probability threshold is equal to 1), and the sum of the weight coefficients corresponding to the frame vectors in the fourth frame vector group is equal to 0.8. The frame vector H3 is a frame boundary of a character corresponding to the first frame vector group and a character corresponding to the second frame vector group; the frame vector H5 is a frame boundary of a character corresponding to the second frame vector group and a character corresponding to the third frame vector group; and the frame vector H6 and the frame vector H7 are frame boundaries of a character corresponding to the third frame vector group and a character corresponding to the fourth frame vector group.

In the embodiments of the present application, since the character probability corresponding to the frame vector indicates the probability of recognizing the corresponding character speech based on the frame vector, and multiple frame vectors corresponding to the same piece of character speech are adjacent in the acoustic representation, the character probabilities of adjacent multiple frame vectors are probabilities of recognizing the same piece of character speech based on the corresponding frame vectors. Therefore, the frame vectors can be divided into multiple frame vector groups according to the probability threshold and the character probability corresponding to each frame vector, so that each frame vector group corresponds to one piece of character speech, and the character probabilities corresponding to the frame vectors in the same frame vector group are the probabilities of recognizing the character speech corresponding to that frame vector group. According to the character probabilities corresponding to the frame vectors, the frame vectors included in the acoustic representation are divided into multiple frame vector groups. The number of frame vector groups is the number of characters in the to-be-recognized speech, and each frame vector group corresponds to one character in the to-be-recognized speech, so as to ensure that the number of characters in the to-be-recognized speech can be determined more accurately and the characters corresponding to different frame vector groups in the acoustic representation can be determined accurately, which can ensure the accuracy of performing speech recognition based on the prediction result.

In a possible implementation, when extracting the vector representation of each piece of character speech from the acoustic representation according to the prediction result in step 204, for each frame vector group, products of frame vectors in the frame vector group and corresponding weight coefficients are summed to obtain a vector representation of character speech corresponding to that frame vector group.

As shown in FIG. 3, a vector representation of character speech corresponding to the first frame vector group is E1=H1×0.3+H2×0.5+H3×0.2, a vector representation of character speech corresponding to the second frame vector group is E2=H3×0.1+H4×0.6+H5×0.3, a vector representation of character speech corresponding to the third frame vector group is E3=H5×0.1+H6×0.9, and a vector representation of character speech corresponding to the fourth frame vector group is E4=H7×0.2+H8×0.6.

It should be understood that the frame vectors in each frame vector group are vectors, so the product of the frame vector and the weight coefficient is still a vector, and thus the sum of the products of the respective frame vectors in the same frame vector group and the corresponding weight coefficients is still a vector. Therefore, the vector representation of the character speech is also a vector. For example, the frame vector is a 256-dimensional vector, and then the vector representation of character speech is also a 256-dimensional vector.

In the embodiments of the present application, since the frame vectors in the same frame vector group correspond to the same piece of character speech, and each frame vector has a corresponding character probability, the vector representation of the character speech corresponding to the frame vector group is calculated by synthesizing the frame vectors, so as to ensure that the obtained vector representation of the character speech can reflect the audio feature of the corresponding character speech more accurately. Then the character speech can be recognized more accurately based on the vector representation of the character speech, thereby ensuring the accuracy of speech recognition.

FIG. 4 is a schematic diagram of a speech recognition model provided by an embodiment of the present application. As shown in FIG. 4, the speech recognition model includes an encoder 401, a predictor 402 and a decoder 403. The encoder 401 is configured to obtain an acoustic representation of to-be-recognized speech, and send the obtained acoustic representation to the predictor 402. The predictor 402 is configured to determine a character probability corresponding to each frame vector in the received acoustic representation, predict the number of characters included in the to-be-recognized speech and a frame boundary of each character according to the character probability corresponding to each frame vector to obtain a prediction result, and extract a vector representation of each piece of character speech from the acoustic representation according to the prediction result, where the character probability is used to indicate a probability of recognizing corresponding character speech based on a current frame vector. The decoder 403 is configured to obtain a recognition result of the to-be-recognized speech according to the vector representation of each piece of character speech determined by the predictor 402.

In the embodiment of the present application, after the encoder 401 obtains the acoustic representation of the to-be-recognized speech, the predictor 402 determines the character probability of each frame vector in the acoustic representation, and can then predict the number of characters included in the to-be-recognized speech and the frame boundary of each character according to the character probability, and extract the vector representation of each piece of character speech from the acoustic representation according to the number of characters and the frame boundary. The decoder 403 obtains the recognition result of the to-be-recognized speech based on the vector representation of each piece of character speech. The decoder 403 may be a non-auto-regressive decoder, and vector representations of respective pieces of character speech are decoded simultaneously through the non-auto-regressive decoder to obtain the character corresponding to each piece of character speech, that is, the recognition result of the to-be-recognized speech. Since there is no need to sequentially recognize the respective pieces of character speech in the to-be-recognized speech, the speech recognition model only needs to be called once, which reduces the number of calls to the speech recognition model and thus improves the speed of speech recognition.

In a possible implementation, the speech recognition method in the above embodiments may be executed through the speech recognition model in the above embodiments. The encoder 401 is configured to execute step 201 in the above embodiments, the predictor 402 is configured to execute steps 202 to 204 in the above embodiments, and the decoder 403 is configured to execute step 205 in the above embodiments. Specifically, after inputting the acoustic feature of the to-be-recognized speech into the encoder 401, the encoder 401 encodes the acoustic feature to obtain the acoustic representation, sends the obtained acoustic representation to the predictor 402, and simultaneously sends the acoustic representation to the decoder 403. The predictor 402 sends the vector representation of each piece of character speech in the to-be-recognized speech to the decoder 403 according to the received acoustic representation, and the decoder 403 outputs the recognition result of the to-be-recognized speech according to the received acoustic representation and the vector representation of each piece of character speech.

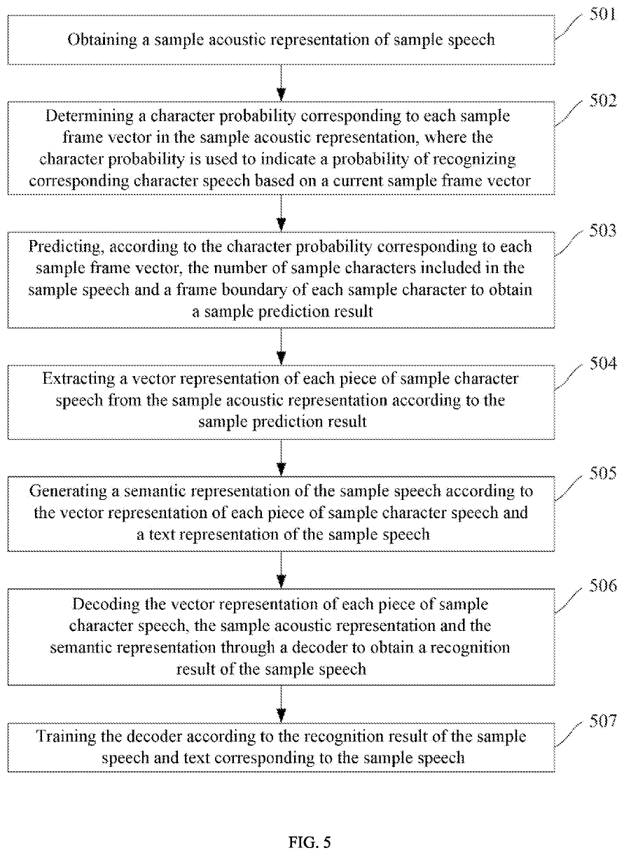

The decoder 403 in the speech recognition model is trained to acquire an ability to recognize the to-be-recognized speech based on the acoustic representations of the to-be-recognized speech and the vector representation of each piece of character speech. FIG. 5 is a flowchart of a decoder training method provided by an embodiment of the present application, which is used to train the decoder 403 in the above embodiments. As shown in FIG. 5, the decoder training method includes the following steps.

Step 501: obtaining a sample acoustic representation of sample speech.

The sample speech is speech data obtained for training a speech recognition model. In order to train the speech recognition model through the sample speech, the sample speech needs to be labeled to obtain text corresponding to the sample speech.

Step 502: determining a character probability corresponding to each sample frame vector in the sample acoustic representation, where the character probability is used to indicate a probability of recognizing corresponding character speech based on a current sample frame vector.

Step 503: predicting, according to the character probability corresponding to each sample frame vector, the number of sample characters included in the sample speech and a frame boundary of each sample character to obtain a sample prediction result.

Step 504: extracting a vector representation of each piece of sample character speech from the sample acoustic representation according to the sample prediction result.

It should be noted that the processing of the sample speech in steps 501 to 504 is consistent with the processing of the to-be-recognized speech in steps 201 to 204 in the aforementioned embodiments, and details thereof can be found in the description of steps 201 to 204 in the aforementioned embodiments, which will not be repeated here.

Step 505: generating a semantic representation of the sample speech according to the vector representation of each piece of sample character speech and a text representation of the sample speech.

Since the vector representation of each piece of sample character speech is extracted separately from the acoustic representation of the sample speech, the vector representations of respective pieces of sample character speech cannot reflect a contextual relationship of sample characters in the sample speech. However, the text representation of the sample speech is generated based on the text corresponding to the sample speech, so the text representation of the sample speech can reflect the contextual relationship of the sample characters in the sample speech. Therefore, the semantic representation of the sample speech can be generated according to the vector representations of the sample character speech and the text representation of the sample speech, and the contextual relationship of the sample character speech in the sample speech is indicated through the semantic representation.

Step 506: decoding the vector representation of each piece of sample character speech, the sample acoustic representation and the semantic representation through the decoder to obtain a recognition result of the sample speech.

After obtaining the semantic representation, the vector representation of each piece of sample character speech, the sample acoustic representation and the semantic representation are input into the decoder, and the decoder decodes the vector representation of each piece of sample character speech, the acoustic representation and the semantic representation to obtain the recognition result of the sample speech.

Step 507: training the decoder according to the recognition result of the sample speech and the text corresponding to the sample speech.

After obtaining the recognition result of the sample speech output by the decoder, a model parameter of the decoder is adjusted according to a difference between the recognition result of the sample speech and the text corresponding to the sample speech. The above method is executed on the decoder through multiple pieces of sample speech until the difference between the recognition result of the sample speech and the text corresponding to the sample speech meets a requirement, to complete the training of the decoder.

It should be understood that when the speech recognition model is an end-to-end speech recognition model, the encoder and the predictor will also be trained while training the decoder, and after training, the speech recognition model can accurately perform speech recognition.

In the embodiments of the present application, since the acoustic representation output by the encoder and the vector representations of the character speech output by the predictor cannot reflect the contextual relationship between the character speech, if the decoder is trained only based on the acoustic representation output by the encoder and the vector representations of the character speech output by the predictor, the decoder will have a large error in homophonous character recognition. Therefore, the semantic representation that can indicate the contextual relationship of the character speech is generated according to the vector representations of the sample character speech and the text representation of the sample speech, and the semantic representation is used as one of inputs in the decoder training process, so that the trained decoder can perform speech recognition based on the contextual relationship of the character speech, which improves the accuracy of recognizing homophonous characters, thereby improving the overall recognition accuracy of the speech recognition model.

In a possible implementation, when generating the semantic representation in step 505, the sample acoustic representation and the vector representation of each piece of sample character speech may be decoded through the decoder to obtain a reference recognition result of the sample speech; sampling from the vector representation of each piece of sample character speech and the text representation of the sample speech is performed according to the reference recognition result and the text corresponding to the sample speech, and the semantic representation is obtained according to a sampling result.

In the embodiments of the present application, the reference recognition result output by the decoder according to the sample acoustic representation and the vector representations of the sample character speech is output without considering the contextual relationship between the sample character speech, and thus, the reference recognition result may have a large error in polyphonic character recognition. By performing sampling from the vector representation of each piece of sample character speech and the text representation of the sample speech, generating the semantic representation according to the sampling result, and then training the decoder with the semantic representation as an input of the decoder, the decoder can be enabled to take into account the vector representations of the character speech and the contextual relationship of the character speech during decoding, thereby ensuring that the trained decoder can recognize speech more accurately.

In a possible implementation, when generating the semantic representation through sampling, a Hamming distance between the reference recognition result and the text corresponding to the sample speech can be calculated. Sampling can be performed from the vector representation of each piece of sample character speech and the text representation of the sample speech according to the calculated Hamming distance, and the semantic representation can be obtained according to the sampling result. The number of samples from the text representation of the sample speech is positively correlated with the Hamming distance.

In the embodiments of the present application, the larger the Hamming distance between the reference recognition result and the text corresponding to the sample speech, the greater the error of the decoder for speech recognition based on the vector representations of the sample character speech and the acoustic representation of the sample speech. At this time, when generating the semantic representation, more samples should be taken from the text representation corresponding to the sample speech to generate the semantic representation that can more accurately indicate the contextual relationship between the sample character speech, allowing the decoder to learn the ability to perform speech recognition based on the contextual relationship between the character speech.

It should be noted that when performing sampling from the vector representation of each piece of sample character speech and the text representation of the sample speech, a manner of random sampling may be adopted to take samples from the vector representation of each piece of sample character speech and the text representation of the sample speech respectively. A text representation corresponding to sample character speech with recognition error may also be sampled from the text representation of the sample speech according to the character speech with recognition error in the reference recognition result, and the embodiments of the present application do not limit a specific manner of sampling.

In a possible implementation, when training the decoder in step 507, a first difference between the recognition result of the sample speech and the text corresponding to the sample speech is calculated, and at least one character in the recognition result is randomly replaced to generate a negative sample. Through a preset MWER (Minimum Word Error Rate) loss function, a second difference of the recognition result of the sample speech, the negative sample and the text corresponding to the sample speech are calculated. The decoder is trained according to the first difference and the second difference.

The first difference may be calculated through a cross entropy loss function, a mean square error loss function, etc., which is not limited in the embodiments of the present application.

By randomly replacing at least one character in the recognition result, one or more negative samples are generated, such as generating five negative samples. The second difference of the recognition result of the sample speech, the negative sample and the text corresponding to the sample speech are calculated through the MWER loss function, and then the decoder is trained according to the first difference and the second difference. By randomly generating the negative samples, due to a large difference between the negative sample and the recognition result of the sample speech, the second difference is calculated through the MWER loss function, and the decoder is trained through the first difference and the second difference, which can make the decoder converge faster, shorten the training time of the decoder, and thus improve the efficiency of training the speech recognition model.

In a possible implementation, the decoder is a bidirectional decoder (Bi-decoder). By decoding the acoustic representation of the to-be-recognized speech and the vector representation of each piece of character speech through the bidirectional decoder, the contextual relationship of the character speech can be better utilized in a decoding process and the recognition accuracy of polyphonic characters in the to-be-recognized speech is improved.

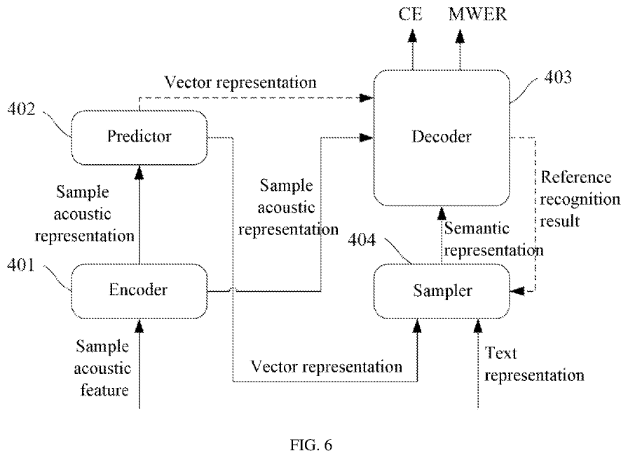

FIG. 6 is a schematic diagram of a decoder training process provided by an embodiment of the present application. As shown in FIG. 6, after inputting a sample acoustic feature (such as a Fbank feature) of sample speech into the encoder 401, the encoder 401 encodes the sample acoustic feature to obtain a sample acoustic representation, and sends the sample acoustic representation to the predictor 402 and the decoder 403, respectively. The predictor 402 predicts the number of sample characters included in the sample speech and a frame boundary of each sample character according to the received sample acoustic representation, obtains the vector representation of each piece of sample character speech according to a prediction result, and sends the vector representation of each piece of sample character speech to the decoder 403 and a sampler 404, respectively. The decoder 403 decodes the received sample acoustic representation and the received vector representation of each piece of sample character speech to obtain a reference recognition result of the sample speech, and then sends the reference recognition result to the sampler 404. The sampler 404 calculates a Hamming distance between the reference recognition result and text corresponding to the sample speech, performs sampling from the vector representation of each piece of sample character speech and the text representation of the sample speech according to the Hamming distance, obtains a semantic representation of the sample speech, and sends the semantic representation of the sample speech to the decoder 403. The decoder 403 decodes the received acoustic representation, the received semantic representation and the received vector representation of each piece of sample character speech to obtain a recognition result of the sample speech, calculates a cross entropy (CE) loss and a minimum word error rate (MWER) loss between the recognition result of the sample speech and the text corresponding to the sample speech, and then optimizes a model parameter of the decoder 403 based on the cross entropy (CE) loss and the minimum word error rate (MWER) loss to realize training of the decoder 403.

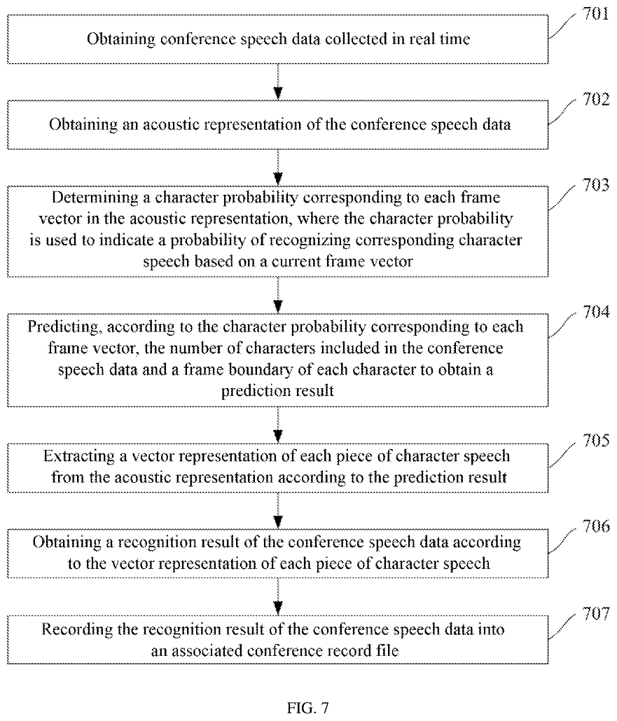

For an application scenario of the solutions provided by the embodiments of the present application in a conference recording system, an embodiment of the present application provides a method for providing a speech recognition service. As shown in FIG. 7, the method for providing a speech recognition service includes the following steps.

Step 701: obtaining conference speech data collected in real time.

Step 702: obtaining an acoustic representation of the conference speech data.

Step 703: determining a character probability corresponding to each frame vector in the acoustic representation, where the character probability is used to indicate a probability of recognizing corresponding character speech based on a current frame vector.

Step 704: predicting, according to the character probability corresponding to each frame vector, the number of characters included in the conference speech data and a frame boundary of each character to obtain a prediction result.

Step 705: extracting a vector representation of each piece of character speech from the acoustic representation according to the prediction result.

Step 706: obtaining a recognition result of the conference speech data according to the vector representation of each piece of character speech.

Step 707: recording the recognition result of the conference speech data into an associated conference record file.

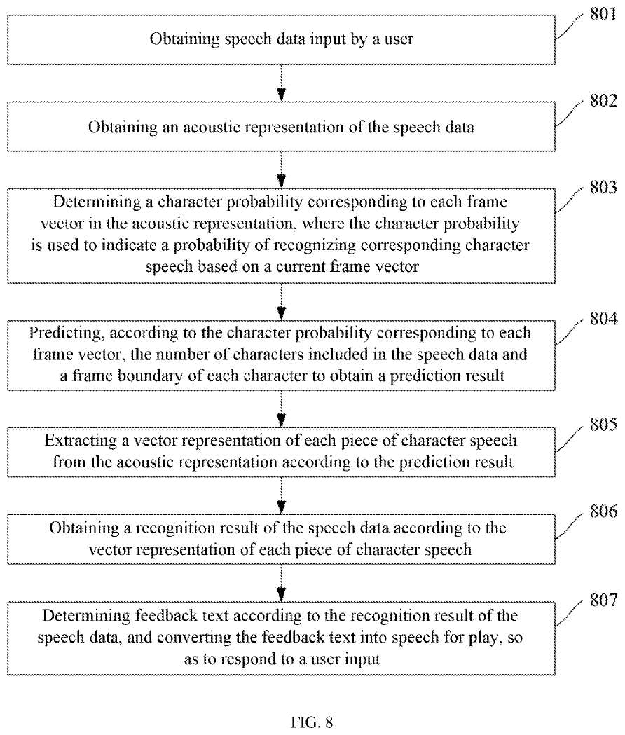

For an application scenario of the solutions provided by the embodiments of the present application in human-machine speech interaction, an embodiment of the present application provides a speech interaction method. As shown in FIG. 8, the speech interaction method includes the following steps.

Step 801: obtaining speech data input by a user.

Step 802: obtaining an acoustic representation of the speech data.

Step 803: determining a character probability corresponding to each frame vector in the acoustic representation, where the character probability is used to indicate a probability of recognizing corresponding character speech based on a current frame vector.

Step 804: predicting, according to the character probability corresponding to each frame vector, the number of characters included in the speech data and a frame boundary of each character to obtain a prediction result.

Step 805: extracting a vector representation of each piece of character speech from the acoustic representation according to the prediction result.

Step 806: obtaining a recognition result of the speech data according to the vector representation of each piece of character speech.

Step 807: determining feedback text according to the recognition result of the speech data, and converting the feedback text into speech for play, so as to respond to a user input.

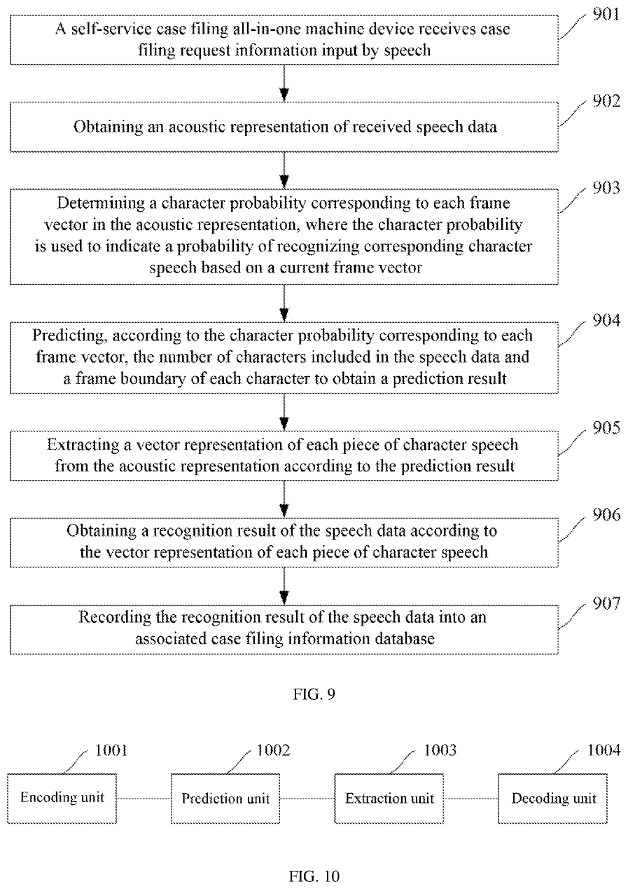

For an application scenario of the solutions provided by the embodiments of the present application in a self-service case filing all-in-one machine of a court, an embodiment of the present application provides a method for implementing court self-service case filing. As shown in FIG. 9, the method for implementing court self-service case filing includes the following steps.

Step 901: a self-service case filing all-in-one machine device receives case filing request information input by speech.

Step 902: obtaining an acoustic representation of received speech data.

Step 903: determining a character probability corresponding to each frame vector in the acoustic representation, where the character probability is used to indicate a probability of recognizing corresponding character speech based on a current frame vector.

Step 904: predicting, according to the character probability corresponding to each frame vector, the number of characters included in the speech data and a frame boundary of each character to obtain a prediction result.

Step 905: extracting a vector representation of each piece of character speech from the acoustic representation according to the prediction result.

Step 906: obtaining a recognition result of the speech data according to the vector representation of each piece of character speech.

Step 907: recording the recognition result of the speech data into an associated case filing information database.

It should be noted that the embodiments shown in FIGS. 7-9 are specific applications of the speech recognition solutions in the embodiments of the present application. Specific speech recognition processes can be found in the description in the aforementioned embodiments and will not be repeated here.

Corresponding to the above method embodiments, FIG. 10 illustrates a schematic diagram of a speech recognition apparatus. As shown in FIG. 10, the speech recognition apparatus includes:
an encoding unit 1001, configured to obtain an acoustic representation of to-be-recognized speech;
a prediction unit 1002, configured to determine a character probability corresponding to each frame vector in the acoustic representation, and predict, according to the character probability corresponding to each frame vector, the number of characters included in the to-be-recognized speech and a frame boundary of each character to obtain a prediction result, where the character probability is used to indicate a probability of recognizing corresponding character speech based on a current frame vector;
an extraction unit 1003, configured to extract a vector representation of each piece of character speech from the acoustic representation according to the prediction result;
a decoding unit 1004, configured to obtain a recognition result of the to-be-recognized speech according to the vector representation of each piece of character speech.

It should be noted that the speech recognition apparatus of this embodiment is configured to implement the corresponding speech recognition methods in the aforementioned method embodiments, and has beneficial effects of the corresponding method embodiments, which will not be repeated here.

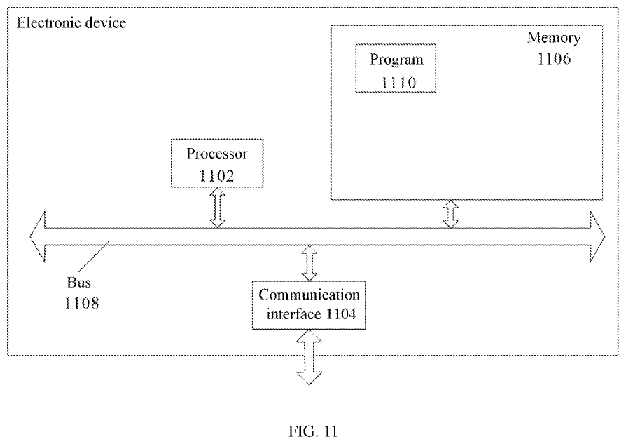

FIG. 11 is a schematic block diagram of an electronic device provided by an embodiment of the present application. Specific embodiments of the present application do not limit the specific implementation of the electronic device. As shown in FIG. 11, the electronic device may include: a processor 1102, a communications interface 1104, a memory 1106 and a communication bus 1108, where:
the processor 1102, the communication interface 1104 and the memory 1106 communicate with each other through the communication bus 1108;
the communication interface 1104 is configured to communicate with other electronic devices or servers;
the processor 1102 is configured to execute a program 1110, and can specifically execute relevant steps in any of the aforementioned speech recognition method embodiments.

Specifically, the program 1110 may include program code, and the program code includes computer operating instructions.

The processor 1102 may be a CPU (Central Processing Unit), a specific integrated circuit ASIC, or one or more integrated circuits configured to implement embodiments of the present application. One or more processors included in an intelligent device may be processors of the same type, such as one or more CPUs, or may also be processors of different types, such as one or more CPUs and one or more ASICs.

The memory 1106 is configured to store the program 1110. The memory 1106 may include a high-speed RAM (random access memory), or may also include a non-volatile memory, such as at least one disk storage.

The program 1110 may be specifically configured to cause the processor 1102 to execute the methods according to any of the aforementioned embodiments.

The specific implementation of each step in the program 1110 can be found in the corresponding description of the corresponding steps and units of any of the aforementioned speech recognition method embodiments, and will not be repeated here. Those skilled in the art can clearly understand that, for the convenience and conciseness of the description, the specific working processes of the devices and modules described above can be found in the corresponding process description in the aforementioned method embodiments, and will not be repeated here.

Through the electronic device of the embodiments of the present application, after obtaining the acoustic representation of the to-be-recognized speech, the character probability of each frame vector in the acoustic representation is determined, and then the number of characters included in the to-be-recognized speech and the frame boundary of each character can be predicted according to the character probability. Based on the number of characters and the frame boundary, the vector representation of each piece of character speech can be extracted from the acoustic representation, and then the recognition result of the to-be-recognized speech can be obtained based on the vector representation of each piece of character speech. After obtaining the vector representation of each piece of character speech, the vector representation of each piece of character speech can be input into a non-auto-regressive decoder. The vector representations of respective pieces of character speech are decoded simultaneously through the non-auto-regressive decoder to obtain a character corresponding to each piece of character speech, that is, to obtain the recognition result of the to-be-recognized speech. Since there is no need to sequentially recognize the respective pieces of character speech in the to-be-recognized speech, the speech recognition model only needs to be called once, which reduces the number of calls to the speech recognition model and thus improves the speed of speech recognition.

The present application further provides a computer-readable storage medium, which stores instructions for causing a machine to execute the speech recognition method as described herein. Specifically, a system or an apparatus equipped with the storage medium may be provided, and software program code that implements functions of any of the embodiments in the aforementioned embodiments is stored. A computer (or CPU or MPU) of the system or the apparatus is caused to read and execute the program code stored in the storage medium.

In this case, the program code itself read from the storage medium can implement the functions of any of the embodiments in the aforementioned embodiments, and thus the program code and the storage medium in which the program code is stored constitute a part of the present application.

Embodiments of the storage medium used to provide the program code include a floppy disk, a hard disk, a magneto optical disk, an optical disk (such as CD-ROM, CD-R, CD-RW, DVD-ROM, DVD-RAM, DVD-RW, DVD+RW), a magnetic tape, a non-volatile storage card and a ROM. In an implementation, the program code may be downloaded from a server computer via a communication network.

An embodiment of the present application further provides a computer program product including computer instructions, and the computer instructions instruct a computing device to execute operations corresponding to any of the above multiple method embodiments.

It should be pointed out that according to implementation needs, the components/steps described in the embodiments of the present application may be split into more components/steps, or two or more components/steps or part of operations of components/steps may be combined into a new component/step, so as to achieve the purposes of the embodiments of the present application.

The above methods according to the embodiments of the present application may be implemented in hardware or firmware, or may be implemented as software or computer code that can be stored in a recording medium (such as CD ROM, RAM, floppy disk, hard disk, or magneto optical disk), or may be implemented as computer code that is originally stored in a remote recording medium or a non-transitory machine-readable medium, downloaded over a network and to be stored in a local recording medium. Thus, the methods described herein may be processed by such software stored on a recording medium using a general-purpose computer, a dedicated processor, or a programmable or dedicated hardware (such as ASIC or FPGA). It can be understood that a computer, a processor, a microprocessor controller or a programmable hardware includes a storage component (such as RAM, ROM, flash memory, etc.) that can store or receive software or computer code. When the software or computer code is accessed and executed by the computer, processor or hardware, the methods described herein are implemented. Furthermore, when a general-purpose computer accesses the code used to implement the methods shown herein, execution of the code converts the general-purpose computer into a dedicated computer used to execute the methods shown herein.

Those with ordinary skill in the art can realize that the units and method steps of the examples described in combination with the embodiments disclosed herein may be implemented in electronic hardware, or a combination of computer software and electronic hardware. Whether these functions are executed in hardware or software depends on the specific application and design constraints of the technical solution. The skilled professional may use a different method to implement the described functions for each specific application, but such implementation should not be considered beyond the scope of the embodiments of the present application.

The above implementations are only used to illustrate the embodiments of the present application, and are not limitations on the embodiments of the present application. Those skilled in the relevant technical field can also make various changes and variations without departing from the spirit and scope of the embodiments of the present application. Therefore, all equivalent technical solutions also belong to the scope of the embodiments of the present application, and the patent protection scope of the embodiments of the present application should be limited by the claims.

1. A speech recognition method, comprising:
obtaining an acoustic representation of to-be-recognized speech;
determining a character probability corresponding to each frame vector in the acoustic representation, wherein the character probability is used to indicate a probability of recognizing corresponding character speech based on a current frame vector;
predicting, according to the character probability corresponding to each frame vector, the number of characters comprised in the to-be-recognized speech and a frame boundary of each character to obtain a prediction result;
extracting a vector representation of each piece of character speech from the acoustic representation according to the prediction result;
obtaining a recognition result of the to-be-recognized speech according to the vector representation of each piece of character speech.

2. The speech recognition method according to claim 1, wherein predicting, according to the character probability corresponding to each frame vector, the number of characters comprised in the to-be-recognized speech and the frame boundary of each character to obtain the prediction result comprises:
dividing, according to the character probability corresponding to each frame vector, frame vectors in the acoustic representation into at least one frame vector group, wherein a sum of weight coefficients corresponding to frame vectors in a same frame vector group is equal to a preset probability threshold, and for a frame vector belonging to two frame vector groups, a sum of corresponding weight coefficients in the two frame vector groups is equal to a character probability corresponding to the frame vector;
the number of characters comprised in the to-be-recognized speech is equal to the number of frame vector groups, and the frame boundary of each character in the to-be-recognized speech is a frame vector located at beginning and a frame vector located at end in a corresponding frame vector group.

3. The speech recognition method according to claim 2, wherein extracting the vector representation of each piece of character speech from the acoustic representation according to the prediction result comprises:
for each frame vector group, summing products of frame vectors in the frame vector group and corresponding weight coefficients to obtain the vector representation of character speech corresponding to the frame vector group.

4. The speech recognition method according to claim 1, wherein the speech recognition method is executed through a speech recognition model, and the speech recognition model comprises an encoder, a predictor and a decoder, wherein the encoder is configured to obtain the acoustic representation of the to-be-recognized speech; the predictor is configured to determine the character probability corresponding to each frame vector in the acoustic representation, predict, according to the character probability corresponding to each frame vector, the number of characters comprised in the to-be-recognized speech and the frame boundary of each character to obtain the prediction result, and obtain the vector representation of each piece of character speech from the acoustic representation according to the prediction result; and the decoder is configured to obtain the recognition result of the to-be-recognized speech according to the vector representation of each piece of character speech;
the decoder is obtained by training as follows:
obtaining a sample acoustic representation of sample speech;
determining a character probability corresponding to each sample frame vector in the sample acoustic representation, wherein the character probability is used to indicate a probability of recognizing corresponding character speech based on a current sample frame vector;
predicting, according to the character probability corresponding to each sample frame vector, the number of sample characters comprised in the sample speech and a frame boundary of each sample character to obtain a sample prediction result;
extracting a vector representation of each piece of sample character speech from the sample acoustic representation according to the sample prediction result;
generating a semantic representation of the sample speech according to the vector representation of each piece of sample character speech and a text representation of the sample speech, wherein the semantic representation is used to indicate a contextual relationship of sample character speech in the sample speech;
decoding the vector representation of each piece of sample character speech, the sample acoustic representation and the semantic representation through the decoder to obtain a recognition result of the sample speech;
training the decoder according to the recognition result of the sample speech and text corresponding to the sample speech.

5. The speech recognition method according to claim 4, wherein generating the semantic representation of the sample speech according to the vector representation of each piece of sample character speech and the text representation of the sample speech comprises:
decoding the sample acoustic representation and the vector representation of each piece of sample character speech through the decoder to obtain a reference recognition result of the sample speech;
performing sampling from the vector representation of each piece of sample character speech and the text representation of the sample speech according to the reference recognition result and the text corresponding to the sample speech, and obtaining the semantic representation according to a sampling result.

6. The speech recognition method according to claim 5, wherein
performing sampling from the vector representation of each piece of sample character speech and the text representation of the sample speech according to the reference recognition result and the text corresponding to the sample speech, and obtaining the semantic representation according to the sampling result comprises:
calculating a Hamming distance between the reference recognition result and the text corresponding to the sample speech;
performing sampling from the vector representation of each piece of sample character speech and the text representation of the sample speech according to the Hamming distance, and obtaining the semantic representation according to the sampling result, wherein the number of samples taken from the text representation of the sample speech is positively correlated with the Hamming distance.

7. The speech recognition method according to claim 4, wherein training the decoder according to the recognition result of the sample speech and the text corresponding to the sample speech comprises:
calculating a first difference between the recognition result of the sample speech and the text corresponding to the sample speech;
randomly replacing at least one character in the recognition result to generate a negative sample;
calculating, through a preset minimum word error rate (MWER) loss function, a second difference of the recognition result of the sample speech, the negative sample and the text corresponding to the sample speech;
training the decoder according to the first difference and the second difference.

8. The speech recognition method according to claim 4, wherein the decoder is a bidirectional decoder.

9. A method for providing a speech recognition service, comprising:
obtaining conference speech data collected in real time;
obtaining an acoustic representation of the conference speech data;
determining a character probability corresponding to each frame vector in the acoustic representation, wherein the character probability is used to indicate a probability of recognizing corresponding character speech based on a current frame vector;
predicting, according to the character probability corresponding to each frame vector, the number of characters comprised in the conference speech data and a frame boundary of each character to obtain a prediction result;
extracting a vector representation of each piece of character speech from the acoustic representation according to the prediction result;
obtaining a recognition result of the conference speech data according to the vector representation of each piece of character speech;
recording the recognition result of the conference speech data into an associated conference record file.

10. (canceled)

11. (canceled)

12. A speech recognition model, comprising:
an encoder, configured to obtain an acoustic representation of to-be-recognized speech;
a predictor, configured to determine a character probability corresponding to each frame vector in the acoustic representation, and predict, according to the character probability corresponding to each frame vector, the number of characters comprised in the to-be-recognized speech and a frame boundary of each character to obtain a prediction result, and extract a vector representation of each piece of character speech from the acoustic representation according to the prediction result, wherein the character probability is used to indicate a probability of recognizing corresponding character speech based on a current frame vector;
a decoder, configured to obtain a recognition result of the to-be-recognized speech according to the vector representation of each piece of character speech.

13. An electronic device, comprising a processor, a memory, a communication interface and a communication bus, wherein the processor, the memory and the communication interface communicate with each other through the communication bus;
the memory is configured to store at least one executable instruction, and the executable instruction causes the processor to execute operations corresponding to the speech recognition method according to claim 1.

14. A non-transitory computer storage medium, having a computer program stored thereon, wherein when the program is executed by a processor, the speech recognition method according to claim 1 is implemented.

15. (canceled)

16. The electronic device according to claim 13, wherein the executable instruction causes the processor to execute the following operations:
dividing, according to the character probability corresponding to each frame vector, frame vectors in the acoustic representation into at least one frame vector group, wherein a sum of weight coefficients corresponding to frame vectors in a same frame vector group is equal to a preset probability threshold, and for a frame vector belonging to two frame vector groups, a sum of corresponding weight coefficients in the two frame vector groups is equal to a character probability corresponding to the frame vector;
the number of characters comprised in the to-be-recognized speech is equal to the number of frame vector groups, and the frame boundary of each character in the to-be-recognized speech is a frame vector located at beginning and a frame vector located at end in a corresponding frame vector group.

17. The electronic device according to claim 16, wherein the executable instruction causes the processor to further execute the following operations:
for each frame vector group, summing products of frame vectors in the frame vector group and corresponding weight coefficients to obtain the vector representation of character speech corresponding to the frame vector group.

18. The electronic device according to claim 13, wherein the speech recognition method is executed through a speech recognition model, and the speech recognition model comprises an encoder, a predictor and a decoder, wherein the encoder is configured to obtain the acoustic representation of the to-be-recognized speech; the predictor is configured to determine the character probability corresponding to each frame vector in the acoustic representation, predict, according to the character probability corresponding to each frame vector, the number of characters comprised in the to-be-recognized speech and the frame boundary of each character to obtain the prediction result, and obtain the vector representation of each piece of character speech from the acoustic representation according to the prediction result; and the decoder is configured to obtain the recognition result of the to-be-recognized speech according to the vector representation of each piece of character speech;
the decoder is obtained by training as follows:
obtaining a sample acoustic representation of sample speech;
determining a character probability corresponding to each sample frame vector in the sample acoustic representation, wherein the character probability is used to indicate a probability of recognizing corresponding character speech based on a current sample frame vector;
predicting, according to the character probability corresponding to each sample frame vector, the number of sample characters comprised in the sample speech and a frame boundary of each sample character to obtain a sample prediction result;
extracting a vector representation of each piece of sample character speech from the sample acoustic representation according to the sample prediction result;
generating a semantic representation of the sample speech according to the vector representation of each piece of sample character speech and a text representation of the sample speech, wherein the semantic representation is used to indicate a contextual relationship of sample character speech in the sample speech;
decoding the vector representation of each piece of sample character speech, the sample acoustic representation and the semantic representation through the decoder to obtain a recognition result of the sample speech;
training the decoder according to the recognition result of the sample speech and text corresponding to the sample speech.

19. The electronic device according to claim 18, wherein the executable instruction causes the processor to further execute the following operations:
decoding the sample acoustic representation and the vector representation of each piece of sample character speech through the decoder to obtain a reference recognition result of the sample speech;
performing sampling from the vector representation of each piece of sample character speech and the text representation of the sample speech according to the reference recognition result and the text corresponding to the sample speech, and obtaining the semantic representation according to a sampling result.

20. The electronic device according to claim 19, wherein the executable instruction causes the processor to further execute the following operations:
calculating a Hamming distance between the reference recognition result and the text corresponding to the sample speech;
performing sampling from the vector representation of each piece of sample character speech and the text representation of the sample speech according to the Hamming distance, and obtaining the semantic representation according to the sampling result, wherein the number of samples taken from the text representation of the sample speech is positively correlated with the Hamming distance.

21. The electronic device according to claim 18, wherein the executable instruction causes the processor to further execute the following operations:
calculating a first difference between the recognition result of the sample speech and the text corresponding to the sample speech;
randomly replacing at least one character in the recognition result to generate a negative sample;
calculating, through a preset MWER loss function, a second difference of the recognition result of the sample speech, the negative sample and the text corresponding to the sample speech;
training the decoder according to the first difference and the second difference.

22. The electronic device according to claim 18, wherein the decoder is a bidirectional decoder.

23. The storage medium according to claim 14, wherein when the program is executed by a processor, the processor is enabled to:
divide, according to the character probability corresponding to each frame vector, frame vectors in the acoustic representation into at least one frame vector group, wherein a sum of weight coefficients corresponding to frame vectors in a same frame vector group is equal to a preset probability threshold, and for a frame vector belonging to two frame vector groups, a sum of corresponding weight coefficients in the two frame vector groups is equal to a character probability corresponding to the frame vector;
the number of characters comprised in the to-be-recognized speech is equal to the number of frame vector groups, and the frame boundary of each character in the to-be-recognized speech is a frame vector located at beginning and a frame vector located at end in a corresponding frame vector group.
